(19) United States
(12) Patent Application Publication
(10) Pub. No.: US 2008/0050121 A1
(43) Pub. Date: Feb. 28, 2008

(54) Submarine optical transmission systems having optical amplifiers of unitary design

(76) Inventors: Stephen G. Evangelides, Red Bank, NJ (US); Jay P. Morreale, Summit, NJ (US); Michael J. Neubelt, Little Silver, NJ (US); Mark K. Young, Monmouth Junction, NJ (US); Jonathan A. Nagel, Brooklyn, NY (US); David S. DeVincentis, Flanders, NJ (US)

Correspondence Address: MAYER & WILLIAMS PC, 251 NORTH AVENUE WEST, 2ND FLOOR, WESTFIELD, NJ, 07090, US

(21) Appl. No.: 10/870,327

(22) Filed: Jun. 17, 2004

(51) Int. Cl. H04B 10/00

(52) U.S. Cl. 398/105

(57) ABSTRACT

A method for entering a market with high barriers to entry and a plurality of proprietary business elements includes converting at least one of the business elements into a universal business element that can accept a wide variety of inputs from other business elements, while converting a remaining one of the plurality of business elements to commoditized business elements. In addition, a market of a resulting business is limited so that the resulting business straddles a gap between two subdivisions of the market. Thus, a combination of technology and market division enables conversion of otherwise proprietary system to commodity equipment that can work with a wide variety of existing vendor equipment while competing technologically with highly engineered solutions. For example as applied to the undersea telecommunications market, one exemplary embodiment of the present invention employs an optical repeater that can accept any existing submarine cable, in combination with an optical line interface terminal that can accept existing terrestrial terminal equipment. Regarding market division, this embodiment is specifically limited to spans of less than 5000 kilometers, and preferably between 350 and 4000 kilometers, thereby straddling both the long-haul and short-haul markets while providing highly desirable services and capability. By selecting this market segment, the embodiment achieves highly desirable economics without the usual concomitant high engineering costs.

### RELATED APPLICATIONS

The present invention is related to co-pending and commonly assigned U.S. patent application Ser. No. 10/739,929, filed Dec. 18, 2003 and entitled “Method for Commoditizing Elements of Previously Specialized Communications Links,” which is incorporated by reference in its entirety herein.

### FIELD OF THE INVENTION

The present invention is directed generally to methods for converting vertically integrated communications business processes into horizontally integrated communications businesses, and more particularly to a method for converting a vertically integrated communications business into a horizontally integrated communications business that enables new business opportunities for a single entity.

### BACKGROUND

The undersea optical telecommunications market comprises an exemplary vertically integrated business. This market is segmented into short-haul and long-haul operations. Short-haul, or repeater-less systems employ links without powered in-line amplification (hence the term repeater-“less”). Short-haul links typically rely on high optical signal launch power from shore to overcome any inherent loss in the line. Very short point-to-point or latera/spur network topologies are typically implemented using repeater-less technologies. This solution is attractive because of the lower capital costs that result from the elimination of line amplification as well as the associated power supply and power-carrying elements in the undersea cable.

Repeater-less systems are generally limited to links of about 250 km in length. A maximum upper limit of 400-450 km is observed in practice because the line loss, which scales with distance, outstrips available line gain, the ability to launch more power into the line, and the ability of the system to resolve the received optical signal. As a result, repeater-less networks often are forced to incorporate less desirable network landing points, from political or economic standpoints, because of the inherent distance limitation imposed by the underlying non-amplified technology.

By comparison, the long-haul undersea market segment is addressed by highly-engineered technical solutions that are custom designed for each application. In this market segment, very sophisticated transmission techniques are employed to maximize bandwidth capacity and system reach. While the technology used is highly capable, it is also complex and time-consuming to design, test and deploy. Initial capital costs in long-haul systems tend to be very high, although per-bit transport costs are often attractive if the systems are built-out to maximum design capacity through Dense Wavelength Division Multiplexing (DWDM) technology where many data streams at varying wavelengths are simultaneously carried on the same line.

Long-haul technology generally is not economically scalable downwards to systems having shorter length and capacity requirements. As bandwidth demand is less on shorter regional routes compared with the big transoceanic “pipes,” high design capacity is not available to drive the favorable economics associated with the long-haul technology. And, as long-haul technology is expressly designed to meet the long-distance and large bandwidth capacity demanded in the sector, it is simply not possible from feature set and engineering viewpoints to decontent a long-haul platform to meet the more modest requirements of the regional market.

For any new business trying to enter either of these markets, there are significant barriers to entry, including but not limited to high capital investment, long time to market, and large equipment purchases for inventory, which can be obsolete technology in a short period of time.

The present invention is therefore directed to the problem of developing a method and apparatus for enabling a business to enter these markets rapidly and without necessarily satisfying existing barriers to entry.

### SUMMARY OF THE INVENTION

The present invention solves these and other problems by providing a combination of technology and market division that enables conversion of otherwise proprietary systems to commodity equipment that can work with a wide variety of existing vendor equipment while competing technologically with highly engineered solutions.

For example, one exemplary embodiment of the present invention employs a optical repeater that can be used with a wide variety of different existing submarine cables, in combination with an optical line interface terminal that can accept existing terrestrial terminal devices. Regarding market division, this embodiment is specifically limited to spans of less than about 4000 kilometers, thereby straddling and overlapping with both the long-haul and short-haul markets while providing highly desirable services and capability. By selecting this market segment, the embodiment achieves highly desirable economics without the usual concomitant high engineering costs.

In accordance with one aspect of the invention, a method is provided for reducing barriers to entry in a submarine optical communications business. The method begins by establishing a system design for a plurality of submarine optical transmission systems that each include terminal equipment that communicate over an optical transmission path having a plurality of optical amplifiers therein. The system design is established by selecting a single design for optical amplifiers to be employed in each of the plurality of submarine optical transmission systems. In addition, a length is selected for each of the optical transmission paths that is no greater than a maximum system length that allows commodity-based terminal equipment to serve as said terminal equipment. Finally, at least one of the plurality of submarine optical transmission systems is deployed in accordance with this system design.

### BRIEF DESCRIPTION OF THE DRAWINGS

FIG. 1 depicts an exemplary embodiment of an undersea telecommunications system according to one aspect of the present invention.

FIG. 2 depicts a flow chart of a method for reducing barriers to entry in a communications business that operates using highly proprietary technology and single designed systems according to another aspect of the present invention.

FIG. 3 depicts a flow chart of a method for creating a business that operates between short haul and long haul undersea telecommunications markets according to still another aspect of the present invention.

FIG. 4 depicts a flow chart of a method for penetrating a market with high barriers to entry according to yet another aspect of the present invention.

FIG. 5 depicts a flow chart of a business method according to a further aspect of the present invention.

FIG. 6 depicts a flow chart of a method for entering a market with high barriers to entry and a plurality of proprietary business elements according to yet another aspect of the present invention.

FIG. 7 depicts a flow chart of a method for converting a vertical business to a horizontal business according to still another aspect of the present invention.

FIG. 8 depicts a functional block diagram of one embodiment of the optical amplifiers that may be employed in the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

According to one aspect of the present invention, existing Wavelength Division Multiplexed (“WDM”) terrestrial and undersea technologies are merged into a feature-rich, yet low-cost platform that is purpose-built for the regional undersea market—a market that is significant, robust, and totally underserved by incumbent undersea suppliers.

Embodiments of the present invention are designed for undersea networks having maximum link distances of about 5,000 kilometers. Within this sector, the business model tracks extremely well to significant opportunities in the range of 350 to 4,000 kilometers. This range defines a market gap where current short-haul platforms hit a technological limit and long-haul solutions cannot be economically scaled downward.

In addition, an embodiment of an undersea network utilizes a small form factor optical amplifier that integrates with existing pressure housings and cable supplied by other companies to create a very low cost optical line amplifier, which is called a “repeater.”

Optical line interface (OLI) equipment allows transmission terminal equipment from most major terrestrial vendors to drive a market-specific amplified line having carefully managed transmission characteristics, including. for example chromatic dispersion compensation. The OLI provides all the functionality that is required for optical transmission through an undersea transmission line but which is absent from terrestrial transmission terminal equipment. A comprehensive set of system design and integration services wraps around the entire hardware suite to complete this market penetration strategy

By creating a terminal-independent and submarine cable-independent system platform, capital requirements for market entry are minimized while very attractive margins are realized. In addition, a multi-supplier platform provides the greatest leverage against each supplier's fundamental capabilities to ensure that regional network customers gain the most optimized and cost effective solution for the entire deployed network—from land-based terminal and interface equipment, to undersea amplified line, to network installation and maintenance.

Creating an end-to-end solution using commodity equipment from the more competitive terrestrial space drives additional customer benefits. These include: flexibility in network provisioning; network operational transparency; savings in operator training; and sparing costs. These advantages substantially drive down both customers' initial capital costs and operational expense, particularly when compared with less cost-optimized “vertically integrated” and heavily-customized solutions.

The regional undersea market is approximately positioned between short-haul “repeater-less” (also known as the “festoon” market) and the long-haul transoceanic repeatered markets. Typical regional network links (from landing point to landing point) run between 350 to 2,000 km in length and are used to implement intra-regional telecommunication networks and inter-connectivity solutions between regional and high-capacity transoceanic undersea networks. The regional market is characterized by moderate bandwidth capacity requirements compared with the long-haul market. Regional networks require significantly shorter link distances with a practical upper limit of around 5,000 km.

More than a mere “niche,” the regional undersea market represents a very significant opportunity in and by itself as carriers and network operators look to solve “connectivity” rather than capacity concerns.

By providing critically enabling technologies, a collection of outsourced commoditized products can be seamlessly integrated to create a new target market-responsive solution. This technology is divided into undersea and land-based equipment.

The technology developed for the undersea portion according to one aspect of the present invention is purposefully simple, modular, and robust to radically simplify system design, manufacturing and deployment. Development costs, product costs, and time to market are substantially reduced through this approach. The capabilities and feature set of the technology is further carefully selected to balance cost and performance in exact alignment with the requirements of the target market. For example, ultimate bandwidth capacity and fiber counts are both modest by long-haul standards. However, regional undersea customers typically have lower capacity requirements since they do not aggregate as much traffic as trans-oceanic service providers.

The land-based technology of the present invention is designed to perfectly complement the capability of the undersea technology. More specifically as the feature set of the undersea technology is purposefully streamlined to lower costs and increase reliability, the land-based technology requirements decrease as a result, thus opening up a broader range of terminal solutions to the customer. This provides the opportunity to offer a multi-vendor terminal solution through the use of the OLI of the present invention.

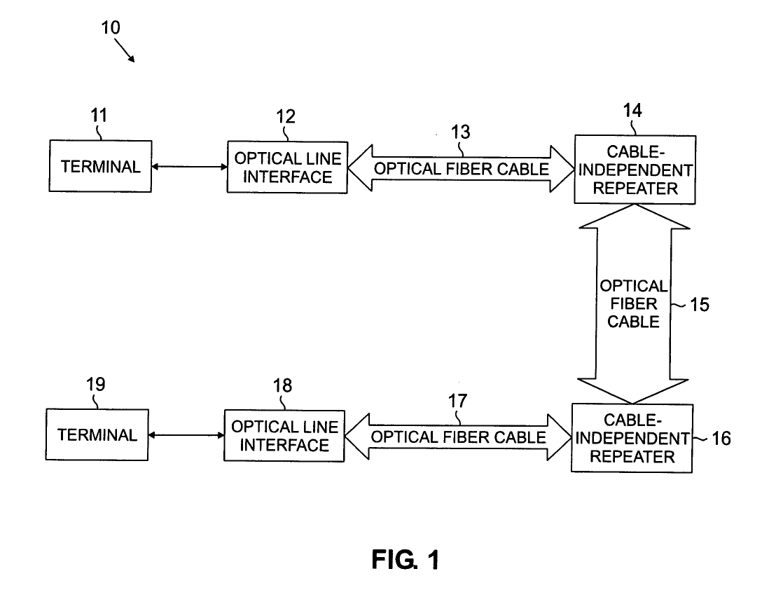

FIG. 1 depicts an exemplary embodiment 10 of a system operating in accordance with one aspect of the present invention. The system includes terminal equipment 11, 19, fiber optic cable segments 13, 15, 17, optical line interfaces 12, 18, and small form factor repeaters 14, 16. While only two repeaters are shown and only three cable segments are shown, other numbers could be used without departing from the scope of the present invention.

### Uniform Optical Amplifier Design For Use Among Different Systems

The repeater of the present invention employs a conventional rare-earth-doped fiber amplifier design, in which the amplifier bandwidth is carefully matched to the capacity requirements of the target market. Low parts count, the use of existing submarine-qualified components, and the judicious use of active controllers simplifies the amplifier design to increase reliability and manufacturability and sharply reduce cost and development time. When deployed in a line designed according to one aspect of the present invention, the amplifier avoids the necessity for bulk gain shape adjustments or dispersion compensation on a per amplifier basis. This results in an amplifier that radically simplifies system integration prior to deployment and increases system maintenance flexibility with a substantial reduction in both as-deployed and as-maintained system cost.

Each rare-earth doped optical amplifier contains a length of doped fiber that provides a gain medium, an energy source that pumps the doped fiber to provide gain, and a means of coupling the pump energy into the doped fiber without interfering with the signal being amplified. The rare-earth element with which the fiber is doped is typically erbium.

In optically amplified WDM communications systems, to achieve acceptable optical-signal-to-noise ratios (OSNR) for all WDM channels it is necessary to have a constant value of gain for all channel wavelengths. This is known as gain flatness and is defined as a low or zero value of the rate of change of gain with respect to wavelength at a fixed input level. Unequal gain distribution adversely affects the quality of the multiplexed optical signal, particularly in long-haul systems where insufficient gain leads to large optical-signal-to-noise ratio degradations and too much gain can cause nonlinearity induced penalties. Accordingly, rare-earth doped optical amplifiers often achieve gain flatness with the use of gain flattening filters.

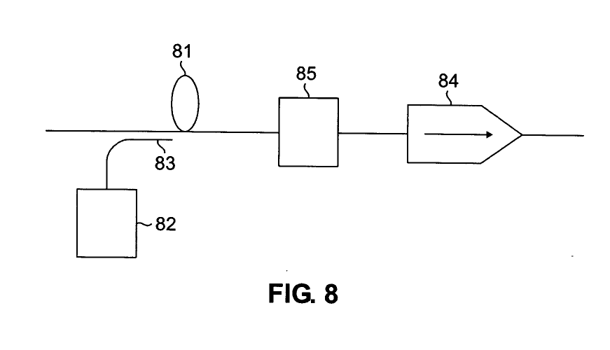

The primary optical components of a rare-earth doped optical amplifier are shown in FIG. 8. The amplifier of FIG. 8 comprises an erbium doped fiber 81, a pump laser 82, a wavelength coupler or multiplexer 83, which multiplexes the pump laser output, and a gain flattening filter 85 located at the output of the doped fiber 81, followed by an optical isolator 84. In operation, the optical signal to be amplified is input via a port of multiplexer 83, multiplexed with the optical pump signal output from laser 82 and amplified in the erbium doped fiber 81.

Traditionally, the aforementioned optical components of the rare-earth doped optical amplifiers employed in submarine optical communications systems are designed and selected on a system-by-system basis to tailor such amplifier characteristics as output power, gain, bandwidth, and gain flatness. That is, doped fiber with different lengths and dopant levels, pump sources with different power levels and different wavelengths, filters with different transmission characteristics, and different insertion losses among the various components, are generally all parameters of the various optical components that must be determined.

In accordance with the present invention, a single design for the rare-earth doped optical amplifiers is employed for multiple submarine transmission systems. This can be readily accomplished because the present invention is predominantly focused on the regional submarine market in which number of wavelengths and system lengths are limited and excess system margin is sacrificed for ease of manufacture.

As used herein, a single optical amplifier design refers to a design in which the various optical components are chosen to be the same from amplifier to amplifier. Such optical components include the rare-earth doped fiber, the pump source or sources, the couplers or multiplexers, and the gain-flattening filter. For example, in some embodiments of the invention the gain-flattening filter may be selected to limit the bandwidth of the optical amplifier to about 28 nm, which minimizes the optical loss that will arise in this component.

A number of advantages accrue from the use of a single optical amplifier design. For example, system design is simplified because the system engineers only need to consider one amplifier design in the system models, inventory requirements for manufacturing are reduced, and system designs may be accomplished in less time. In addition, the cost of the individual optical components may be reduced because more identical components will need to be procured, thereby potentially reducing their per unit cost.

### Small Form Factor Repeater

The aforementioned optical amplifier may be located in a small form factor repeater housing such as that disclosed in U.S. patent application Ser. No. 10/687,547, which U.S. patent application Ser. No. 10/687,547 is hereby incorporated by reference as if repeated herein in its entirety, including the drawings. In this embodiment of the invention the repeater housing comprises an existing submarine qualified pressure and tension housing produced by established suppliers in the submarine space. In one embodiment of the invention the existing submarine qualified pressure and tension housing is conventionally employed to house a submarine cable joint.

In some embodiments of the present invention, the optical amplifiers located in the small form factor repeaters are preferably configured to consume very low power to increase the inherent reliability of the pump lasers, reduce thermal loads, and lessen the power producing and carrying requirements on the DC power supply and undersea cable, respectively. Such a design not only increases overall amplifier reliability, but also substantially lowers costs in the cable because both the power conductor (typically formed from copper) and the dielectric sheathing (typically a medium or high-density polyethylene) can be made smaller in size. When configured as a full up repeater, the ultra-small-form-factor repeater of the present invention generates very small amounts of waste heat and thus can be stored in shipboard cable “tanks” or on deck without external cooling. Such features enhance ease of installation while lowering overall costs.

### Optical Line Interface

U.S. patent application Ser. No. 10/621,028 discloses one embodiment of an Optical Line Interface device that may be employed in an undersea telecommunications system in accordance with the present invention, which U.S. patent application Ser. No. 10/621,028 is hereby incorporated by reference as if repeated herein in its entirety, including the drawings. The land-based optical line interface (“OLI”) 12, 18 provides an open interface that enables a variety of unmodified terrestrial grade terminal products from multiple vendors to drive the undersea-amplified line. The OLI fits between the terminal equipment and the amplified line to provide optical signal conditioning and grooming at both the launch and receive end of the system. In addition, the OLI provides the required line monitoring, power feed, and optical service channel functionalities that are unique to the undersea telecommunications environment.

In its interface role, the OLI ensures that the terminal equipment—independent of terminal vendor, modulation format, launch power and other characteristics—successfully transmits and receives data over the undersea, amplified line. The OLI conditions the optical signal at both transmitter and receiver to compensate for line impairments, such as chromatic dispersion and cross-phase modulation, as well as to improve signal-to-noise ratio in the end-to-end system. Raman amplification may be provided in the OLI to increase system reliability and lower costs by increasing the distance from shore to the first repeater, thereby reducing incidents of external aggression close to shore while simultaneously eliminating or the reducing the need for repeater burial.

### Terminal

Similar to the fiber optic cable, the terminal equipment 11, 19 employed in this system 10 can be conventional land-line terminal equipment. This is another aspect of the present invention, in that most any type of pre-existing terminal equipment can be employed, enabling the system designer to purchase the most cost effective terminal equipment at the time. Moreover, this enables the system operator and builder to avoid maintaining supplies of terminal equipment, thereby reducing the inventory costs associated with this business. As such, this element of the system can be a commodity item. Examples of terminal equipment that are currently available and which may be used in connection with the present invention include, but are not limited to, the Nortel LH1600 and LH4000, Siemens MTS 2, Cisco 15808 and the Ciena CoreStream long-haul transport products. The terminal equipment may also be a network router in which Internet routing is accomplished as well the requisite optical functionality. Moreover, the terminal equipment that is employed may conform to a variety of different protocol standards, such SONET/SDH ATM and Gigabit Ethernet, for example.

In some embodiments of the invention the terminal equipment need not be conventional land-line terminal equipment. Rather, the terminal equipment may be pre-existing undersea terminal equipment available from third party vendors. Such equipment may be available from inventory and hence may prove to be the most cost effective terminal equipment at the time. Significantly, this pre-existing terminal equipment is customized for the third party vendor's own undersea transmission system and not for the regional undersea market addressed by the present invention.

### Exemplary Embodiments

The present inventions set forth herein make possible a wide variety of business methods and processes. Several of these are set forth below. Others should be apparent to those of skill in this art.

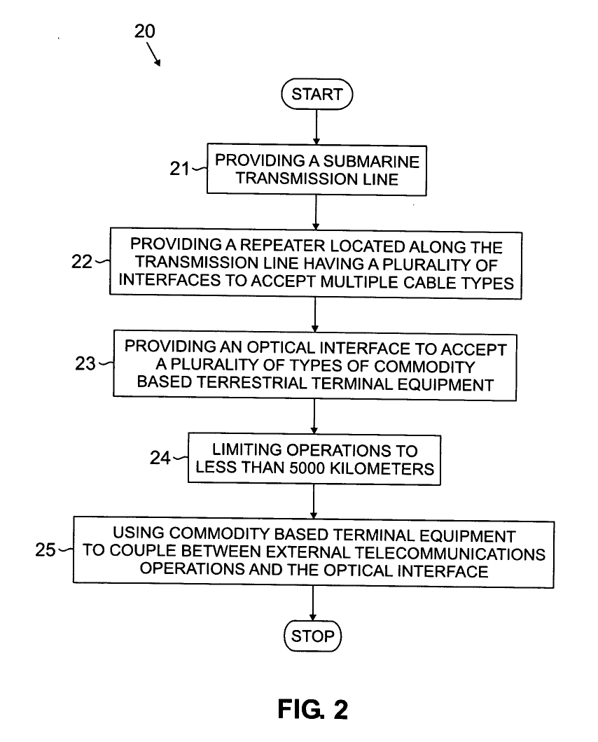

FIG. 2 depicts a flow chart of a method for reducing barriers to entry in a communications business that operates using highly proprietary technology and single designed systems according to another aspect of the present invention. One such system includes the undersea or submarine telecommunications market. According to this method, a submarine transmission line is provided (element 21) as well as a repeater, which repeater is located along the transmission line and has a plurality of interfaces to accept multiple cable types (element 22). In combination with this repeater and transmission line, an optical interface is employed to accept a plurality of commodity-based terrestrial terminal equipment (element 23). Additionally, operations may be limited to within about 5000 kilometers or so (element 24). Moreover, commodity based terminal equipment can be used to couple between external telecommunications operations and the optical interface (element 25). Consequently, a new entity seeking to enter the undersea telecommunications market need not purchase a large amount of inventory for the other elements of an undersea telecommunications system, but rather can purchase these elements on the open market based on other considerations, such as cost, delivery, volume discounts, etc.

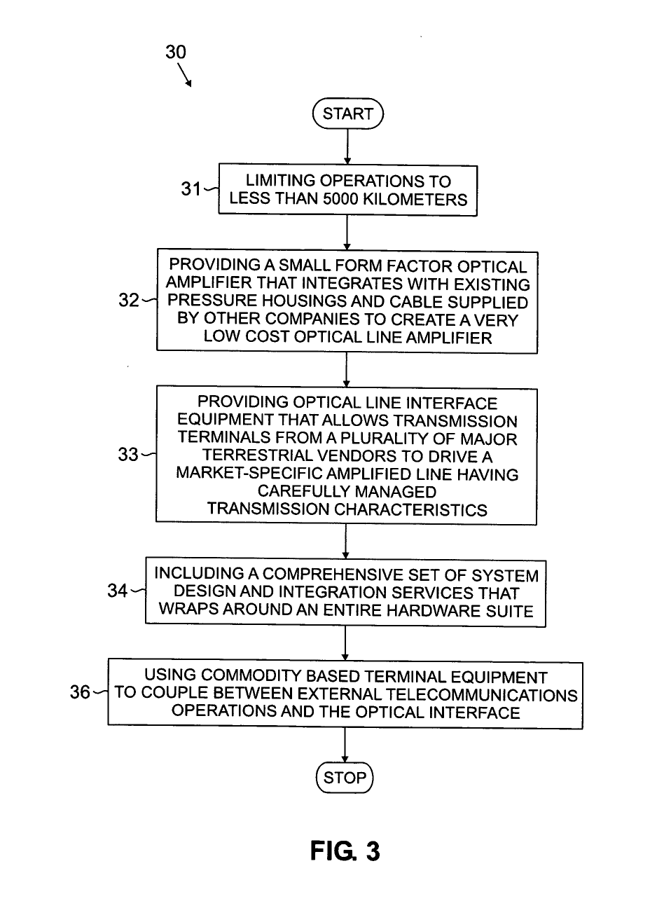

FIG. 3 depicts a flow chart of a method for creating a business that operates between short haul and long haul undersea telecommunications markets according to another aspect of the present invention. In this method, operations are limited to less than 5000 kilometers (element 31). A small form factor optical amplifier is provided, which integrates with existing pressure housings and cable supplied by other companies to create a very low cost optical line amplifier (element 32). Optical line interface equipment is provided, which allows transmission terminals from a plurality of major terrestrial vendors to drive a market-specific amplified line having carefully managed transmission characteristics (element 33). A comprehensive set of system design and integration services wraps around the entire hardware suite to complete this market penetration strategy (element 34). Moreover, commodity based terminal equipment can be used to couple between external telecommunications operations and the optical line interface (element 36). The end result is a system that straddles both the short-haul and long-haul markets, provides some of the benefits of both while not necessarily including the disadvantages of either.

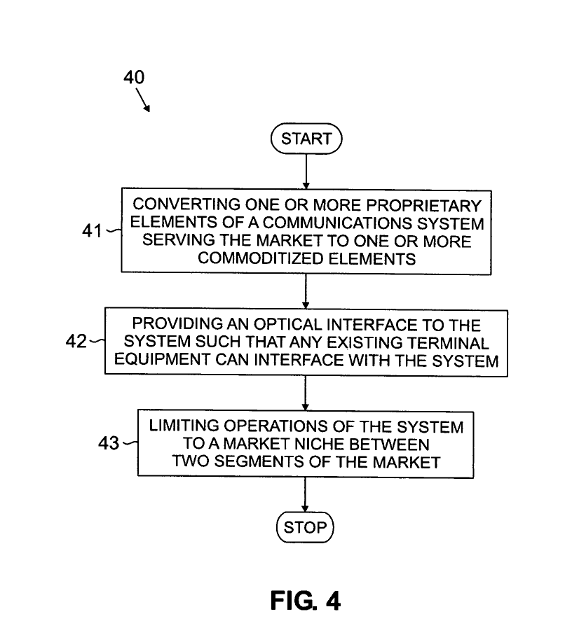

FIG. 4 depicts a flow chart of a general method for penetrating an undersea communications market with high barriers to entry according to yet another aspect of the present invention. According to this method, one or more proprietary elements of a communications system serving the market are converted to one or more commoditized elements (element 41). This is made possible because an optical interface to the system is provided, such that any existing terminal equipment can interface with the system (element 42). This enables the market entrant to use any available equipment rather than proprietary equipment used by existing companies. Operations of the system are then limited to a market niche between two segments of the market (element 43). This enables the market entrant to serve underserved segments of the market. By setting this portion of the market as the target of the business, revenues can be obtained with less competition from existing market participants. This technique or process can be applied to other businesses and not just the undersea telecommunications market.

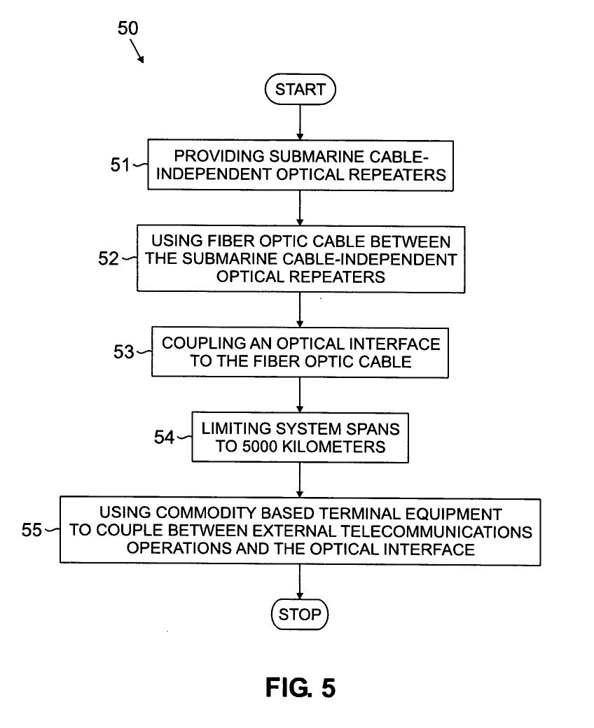

FIG. 5 depicts a flow chart of a business method according to yet another aspect of the present invention. According to this method, submarine cable-independent optical repeaters are provided (element 51). Fiber optic cable is used between the repeaters (element 52). An optical interface is coupled to the fiber optical cable (element 53). System spans are then limited to 5000 kilometers or so (element 54). Moreover, commodity based terminal equipment can be used to couple between external telecommunications operations and the optical interface (element 55). The combination of these elements results in a new business heretofore not possible.

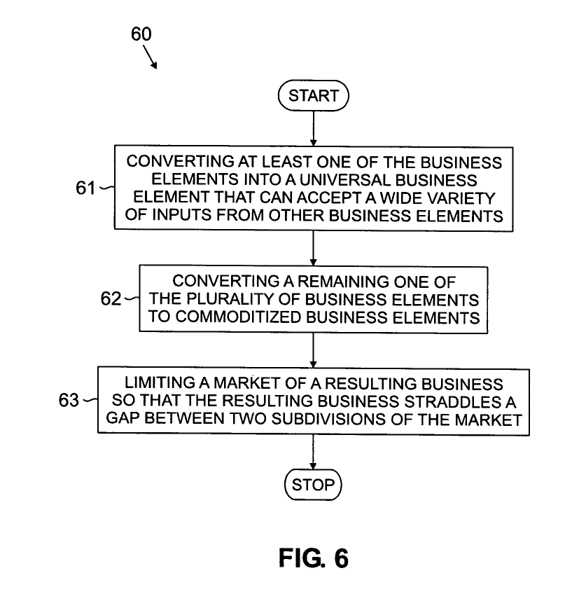

FIG. 6 depicts a flow chart of a general method for entering a market with high barriers to entry and several proprietary business elements according to still another aspect of the present invention. According to this method, at least one of the business elements is converted into a universal business element that can accept a wide variety of inputs from other business elements (element 61). The remaining business elements are converted to commoditized business elements (element 62). A market of a resulting business is limited so that the resulting business straddles a gap between two subdivisions of the market (element 63). This combination of processes enables a market entrant to operate in underserved segments of the market. By setting this portion of the market as the target of the business, revenues can be obtained with less competition from existing market participants. This technique or process can be applied to other businesses—not just the undersea telecommunications market.

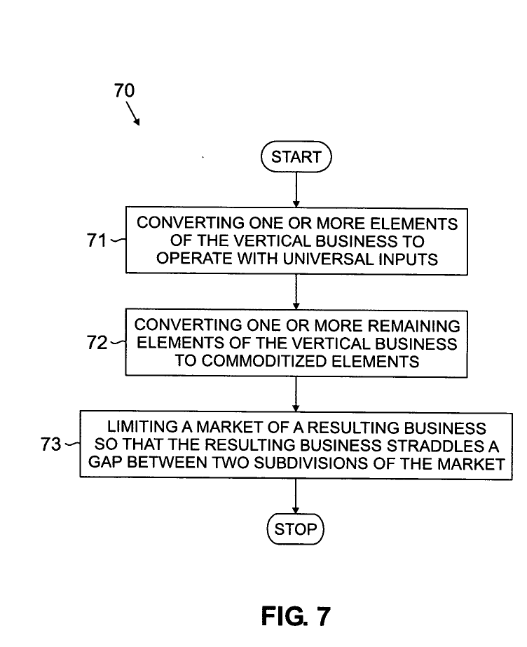

FIG. 7 depicts a flow chart of a general method for converting a vertical business to a horizontal business according to still another aspect of the present invention. According to this method, one or more elements of the vertical business are converted to operate with universal inputs (element 71). One or more of the remaining elements of the vertical business are converted to commoditized elements (element 72). In addition, a market of a resulting business can be limited so that the resulting business straddles a gap between two subdivisions of the market (element 73). As with the above method, this technique can be applied to other businesses—not just the undersea telecommunications market.

Although various embodiments are specifically illustrated and described herein, it will be appreciated that modifications and variations of the invention are covered by the above teachings and are within the purview of the appended claims without departing from the spirit and intended scope of the invention. For example, at least several of the business methods set forth herein are applicable to other markets than the undersea telecommunications market used in the above description. Furthermore, this example should not be interpreted to limit the modifications and variations of the invention covered by the claims but is merely illustrative of possible variations.

What is claimed is:

1. A method for reducing barriers to entry in a submarine optical communications business, comprising:
A. establishing a system design for a plurality of submarine optical transmission systems that each include terminal equipment that communicate over an optical transmission path having a plurality of optical amplifiers therein, wherein said establishing step includes the steps of:
i. selecting a single design for optical amplifiers to be employed in each of the plurality of submarine optical transmission systems;
ii. selecting a length for each of the optical transmission paths that is no greater than a maximum system length that allows commodity-based terminal equipment to serve as said terminal equipment; and
B. deploying at least one of said plurality of submarine optical transmission systems in accordance with the system design set forth in step (A).

2. The method of claim 1 wherein said single optical amplifier design has a common set of optical components that includes a common doped fiber, pump source, gain flattening filter, and a common coupler.

3. The method of claim 1 wherein the step of selecting a single optical amplifier design includes the step of limiting a bandwidth of the optical amplifiers to less than about 28 nm.

4. The method of claim 1 wherein said optical amplifier is designed to located in a repeater housing having a plurality of interfaces to accept multiple cable types.

5. The method of claim 1 wherein said terminal equipment for each of the submarine optical transmission systems comprises commodity-based terrestrial terminal equipment, and further comprising the step of providing an optical interface to provide optical-level connectivity between the optical transmission paths and any of said commodity-based terrestrial terminal equipment.

6. The method of claim 1 wherein the length selecting step includes the step of limiting the length for each of the optical transmission paths to less than about 5000 kilometers.

7. The method of claim 1 wherein the length selecting step includes the step of limiting the length for each of the optical transmission paths to between about 350 km and 4000 km.

8. The method of claim 1 wherein the length selecting step includes the step of limiting the length for each of the optical transmission paths to lengths corresponding to those between conventional short-haul unrepeatered and long-haul repeatered undersea telecommunications systems.

9. The method of claim 1 wherein said repeater housing includes an existing pressure housing supplied by a third party vendor to create a relatively low cost optical repeater for use along the optical transmission line.
